(19) United States
(12) Patent Application Publication
(10) Pub. No.: US 2026/0126794 A1
(43) Pub. Date: May 7, 2026

(54) DETERMINATION APPARATUS AND DETERMINATION METHOD

(71) Applicant: TOYOTA JIDOSHA KABUSHIKI KAISHA, Toyota-shi (JP)

(72) Inventor: Kiyotaka MORIIZUMI, Nisshin-shi (JP)

(73) Assignee: TOYOTA JIDOSHA KABUSHIKI KAISHA, Toyota-shi (JP)

(21) Appl. No.: 19/368,337

(22) Filed: Oct. 24, 2025

(30) Foreign Application Priority Data
Nov. 6, 2024 (JP) 2024-194762

(51) Int. Cl. G05D 1/227; G05D 1/248; G05D 107/13; G05D 109/10; G05D 111/10; G05D 111/30

(52) U.S. Cl. CPC G05D 1/227; G05D 1/248; G05D 2107/13; G05D 2109/10; G05D 2111/17; G05D 2111/30

(57) ABSTRACT

A determination apparatus includes a controller configured to, while a vehicle that has an automated driving mode and a temporary manual driving mode becoming selectable by connecting a temporary manual driving apparatus is traveling in the automated driving mode, request a first transition that is a transition from the automated driving mode to the temporary manual driving mode when an operational design domain enabling automated driving has become unsatisfied.

### CROSS-REFERENCE TO RELATED APPLICATION

This application claims priority to Japanese Patent Application No. 2024-194762 filed on Nov. 6, 2024, the entire contents of which are incorporated herein by reference.

### TECHNICAL FIELD

The present disclosure relates to a determination apparatus and a determination method.

### BACKGROUND

Technology for automatically controlling travel of vehicles is known. For example, Patent Literature (PTL) 1 discloses a vehicle that has two driving modes, i.e., an automated driving mode in which travel of the vehicle is automatically controlled and a manual driving mode in which travel of the vehicle is controlled according to operations of an operator who is on board the vehicle. The vehicle has a mechanical operation unit for driving control of the vehicle by operations of the operator in the manual driving mode.

### CITATION LIST

### Patent Literature

PTL 1: JP 2022-096813 A

### SUMMARY

However, when automated driving has become in practical use, vehicles may not be equipped with mechanical operation units for manual driving. Even in such cases, it is necessary to take fail-safe measures smoothly. Therefore, there is room for improvement in technology for automatically controlling travel of vehicles.

It would be helpful to improve technology for automatically controlling travel of vehicles.

A determination apparatus according to an embodiment of the present disclosure includes a controller configured to:
acquire data measured by a sensor provided in a vehicle that has an automated driving mode and a temporary manual driving mode, the temporary manual driving mode becoming selectable by connecting a temporary manual driving apparatus; and
while the vehicle is traveling based on the data in the automated driving mode, request a first transition that is a transition from the automated driving mode to the temporary manual driving mode, when an operational design domain enabling automated driving has become unsatisfied.

A determination apparatus according to an embodiment of the present disclosure includes a controller configured to, while a vehicle that has an automated driving mode and a temporary manual driving mode becoming selectable by connecting a temporary manual driving apparatus is traveling in the automated driving mode, request a first transition that is a transition from the automated driving mode to the temporary manual driving mode when an operational design domain enabling automated driving has become unsatisfied.

A determination method according to an embodiment of the present disclosure includes, while a vehicle that has an automated driving mode and a temporary manual driving mode becoming selectable by connecting a temporary manual driving apparatus is traveling in the automated driving mode, requesting, by a determination apparatus, a first transition that is a transition from the automated driving mode to the temporary manual driving mode, when an operational design domain enabling automated driving has become unsatisfied.

According to an embodiment of the present disclosure, technology for automatically controlling travel of vehicles is improved.

### BRIEF DESCRIPTION OF THE DRAWINGS

In the accompanying drawings:

FIG. 1 is a block diagram illustrating an example of a schematic configuration of a system according to an embodiment of the present disclosure;

FIG. 2 is a flowchart illustrating an example of operations of a determination apparatus; and

FIG. 3 is a table illustrating an example of transitions of driving modes depending on factors for which an operational design domain is unsatisfied.

### DETAILED DESCRIPTION

Hereinafter, an embodiment of the present disclosure will be described.

### Outline of Embodiment

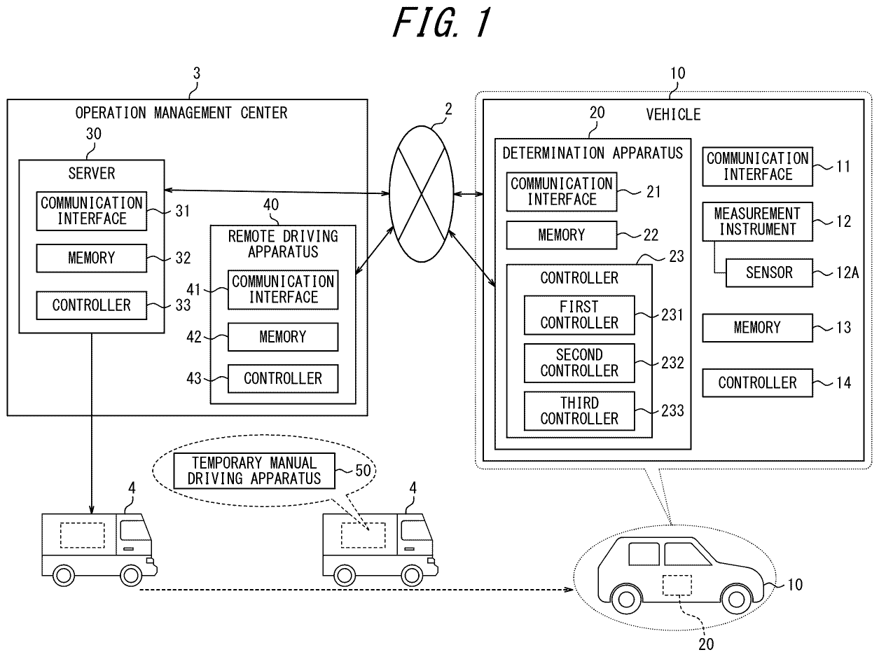

An outline of a system 1 according to the embodiment of the present disclosure will be described with reference to FIG. 1. The system 1 includes a vehicle 10, a determination apparatus 20 mounted on the vehicle 10, a server 30 and a remote driving apparatus 40 installed in an operation management center 3, and a temporary manual driving apparatus 50 to be temporarily installed in the vehicle 10. The vehicle 10, the determination apparatus 20, the server 30, and the remote driving apparatus 40 are communicably connected to a network 2 including, for example, the Internet, a mobile communication network, or the like.

The vehicle 10 is an automobile that has, for example, a Level 4 (Lv4) automated driving function. The automobile is a gasoline vehicle, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 provided in the system 1 may be freely determined. The vehicle 10 can communicate with the determination apparatus 20, the server 30, and the remote driving apparatus 40 via the network 2. The vehicle 10 may communicate with the determination apparatus 20 via a wire.

The determination apparatus 20 is a computer mounted on the vehicle 10. The determination apparatus 20 can communicate with the vehicle 10, the server 30, and the remote driving apparatus 40 via the network 2. The determination apparatus 20 may communicate with the vehicle 10 via a wire.

The server 30 is a computer managed by the operation management center 3. The server 30 can communicate with the vehicle 10, the determination apparatus 20, and the remote driving apparatus 40 via the network 2. However, a manager of the server 30 is not limited to the operation management center 3.

The remote driving apparatus 40 is a control apparatus installed in the operation management center 3. By operations of an operator at the operation management center 3, which is located remotely from the vehicle 10, the remote driving apparatus 40 monitors and manually drives the vehicle 10 via the network 2. The remote driving apparatus 40 can communicate with the vehicle 10, the determination apparatus 20, and the server 30 via the network 2.

The temporary manual driving apparatus 50 is an apparatus that an operator of a rescue team 4 who has received a request from the server 30 temporarily installs in the vehicle 10 that does not have a mechanical operation unit for manual driving, to enable the vehicle 10 to be driven by manual operations. The rescue team 4 is on standby at a rescue center provided in or away from the operation management center 3.

First, an outline of the present embodiment will be described, and details thereof will be described later. While the vehicle 10 that has an automated driving mode and a temporary manual driving mode, which becomes selectable by connecting the temporary manual driving apparatus 50, is traveling in the automated driving mode, the determination apparatus 20 requests a first transition that is a transition from the automated driving mode to the temporary manual driving mode when an operational design domain enabling automated driving has become unsatisfied.

According to the present embodiment, while the vehicle 10 is traveling by automated driving, the determination apparatus 20 autonomously requests a transition from the automated driving mode to the temporary manual driving mode when the operational design domain has become unsatisfied. As a result, time for the transition from the automated driving mode to the temporary manual driving mode is further reduced. It also becomes possible to smoothly take fail-safe measures even in situations in which automated driving is impossible, thereby improving technology for automatically controlling travel of vehicles.

Next, configurations of the system 1 will be described in detail.

### Configuration of Vehicle

As illustrated in FIG. 1, the vehicle 10 includes a communication interface 11, a measurement instrument 12, a memory 13, a controller 14, and the determination apparatus 20. The details of the determination apparatus 20 will be described later.

The communication interface 11 includes both a communication interface that is wirelessly connected to the network 2 and a communication interface that is connected with a wire to a controller area network (CAN). The communication interface that is connected to the network 2 is compliant with a mobile communication standard such as the 4th generation (4G) or the 5th generation (5G), but is not limited to these.

The measurement instrument 12 includes a sensor 12A. The sensor 12A, which includes cameras, 3D-LiDAR, millimeter wave sensors, an acceleration sensor, or a GPS sensor, includes sensors to monitor environment around the vehicle 10 that travels by automated driving, and sensors that are mounted on a self-diagnostic apparatus or the like of the vehicle 10 to diagnose a failure mode. However, the sensor 12A is not limited to these.

The memory 13 includes one or more memories. The memories are, for example, semiconductor memories, magnetic memories, optical memories, or the like, but are not limited to these. The memories included in the memory 13 may each function as, for example, a main memory, an auxiliary memory, or a cache memory. The memory 13 stores any information to be used for operations of the vehicle 10. For example, the memory 13 may store a system program, an application program, embedded software, and the like. The information stored in the memory 13 may be updated with information acquired from the network 2 via the communication interface 11, for example.

The controller 14 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 14 controls operations of the entire vehicle 10, including Lv4 automated driving and manual driving linked with the remote driving apparatus 40 or the temporary manual driving apparatus 50 described later.

### Configuration of Determination Apparatus

As illustrated in FIG. 1, the determination apparatus 20 includes a communication interface 21, a memory 22, and a controller 23.

The communication interface 21 includes both a communication interface that is wirelessly connected to the network 2 and a communication interface that is connected with a wire to the CAN. The communication interface that is connected to the network 2 is compliant with a mobile communication standard such as 4G or 5G, for example, but is not limited to these.

The memory 22 includes one or more memories. The memories are, for example, semiconductor memories, magnetic memories, optical memories, or the like, but are not limited to these. The memories included in the memory 22 may each function as, for example, a main memory, an auxiliary memory, or a cache memory. The memory 22 stores any information to be used for operations of the determination apparatus 20. For example, the memory 22 may store a system program, an application program, embedded software, and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls operations of the entire determination apparatus 20.

As illustrated in FIG. 1, in the present embodiment, the controller 23 functions as a first controller 231, a second controller 232, and a third controller 233.

The first controller 231 constantly monitors, based on data or the like measured by the sensor 12A, whether an operational design domain enabling the vehicle 10 to travel by automated driving is satisfied.

The second controller 232 determines a factor for which the operational design domain, which enables the vehicle 10 to travel by automated driving, has become unsatisfied.

The third controller 233 selects a countermeasure depending on the factor for which the operational design domain, which enables the vehicle 10 to travel by automated driving, has become unsatisfied, and requests the server 30 operated by the operation management center 3 to take the countermeasure depending on the factor.

### Configuration of Server

As illustrated in FIG. 1, the server 30 includes a communication interface 31, a memory 32, and a controller 33.

The communication interface 31 includes at least one communication interface for connecting to the network 2. The communication interface is compliant with, for example, a mobile communication standard, a wired LAN standard, or a wireless LAN standard, but not limited to these, and may be compliant with any communication standard.

The memory 32 includes one or more memories. The memories are, for example, semiconductor memories, magnetic memories, optical memories, or the like, but are not limited to these. The memories included in the memory 32 may each function as, for example, a main memory, an auxiliary memory, or a cache memory. The memory 32 stores any information to be used for operations of the server 30. For example, the memory 32 may store a system program, an application program, embedded software, or the like. The information stored in the memory 32 may be updated with, for example, information acquired from the network 2 via the communication interface 31.

The controller 33 includes at least one processor, at least one programmable circuit, at least one dedicated circuit, or a combination of these. The controller 33 controls operations of the entire server 30.

### Configuration of Remote Driving Apparatus

As illustrated in FIG. 1, the remote driving apparatus 40 includes a communication interface 41, a memory 42, and a controller 43.

The communication interface 41 includes at least one communication interface for connecting to the network 2. The communication interface is compliant with, for example, a mobile communication standard, a wired LAN standard, or a wireless LAN standard, but not limited to these, and may be compliant with any communication standard.

The memory 42 includes one or more memories. The memories are, for example, semiconductor memories, magnetic memories, optical memories, or the like, but are not limited to these. The memories included in the memory 42 may each function as, for example, a main memory, an auxiliary memory, or a cache memory. The memory 42 stores any information to be used for operations of the remote driving apparatus 40. For example, the memory 42 may store a system program, an application program, embedded software, or the like. The information stored in the memory 42 may be updated with, for example, information acquired from the network 2 via the communication interface 41.

The controller 43 includes at least one processor, at least one programmable circuit, at least one dedicated circuit, or a combination of these. The controller 43 controls operations of the entire remote driving apparatus 40.

### Flow of Operations of Determination Apparatus

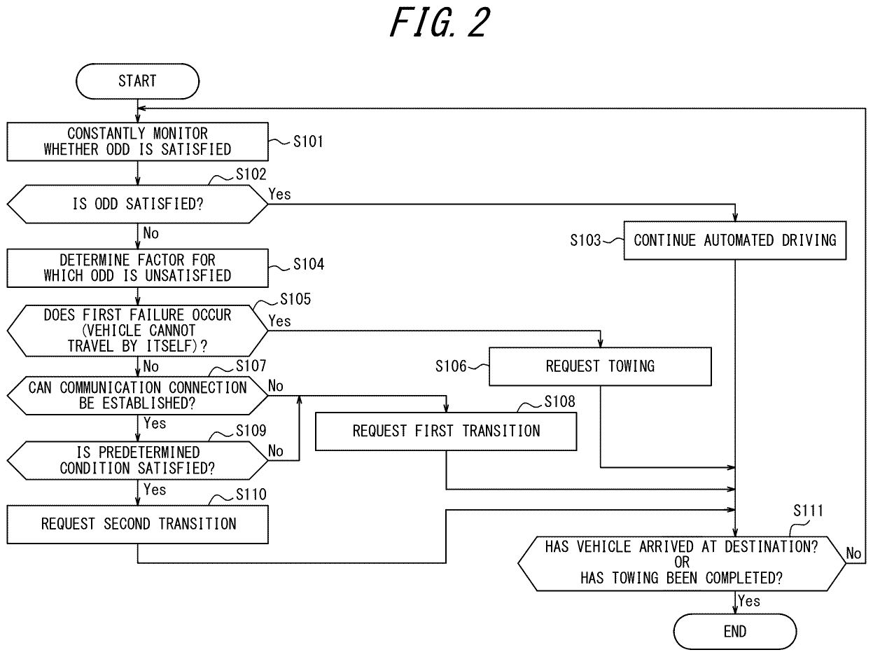

Operations of the determination apparatus 20 according to the present embodiment will be described with reference to FIG. 2. While the vehicle 10 that has an automated driving mode AD and a temporary manual driving mode HCD, which becomes selectable by connecting the temporary manual driving apparatus 50, is traveling by automated driving, when an operational design domain (hereinafter also referred to as ODD) enabling automated driving has become unsatisfied, a transition from the automated driving mode AD to a manual driving mode is required to continue the travel of the vehicle 10. The manual driving mode includes a remote driving mode RD and the temporary manual driving mode HCD, as described later. The operations relate to transitions of driving modes of the vehicle 10 in which the ODD has become unsatisfied.

S101: The controller 23 constantly monitors whether the ODD is satisfied, based on data measured by the sensor 12A provided in the vehicle 10.

The sensor 12A, which includes cameras, 3D-LiDAR, millimeter wave sensors, an acceleration sensor, or a GPS sensor, includes sensors to monitor environment around the vehicle 10 that travels by Lv4 automated driving, and sensors that are mounted on the self-diagnostic apparatus or the like of the vehicle 10 to diagnose a failure mode. However, the sensor 12A is not limited to these. The controller 23 acquires the data measured by the sensor 12A from the measurement instrument 12 of the vehicle 10.

S102: The controller 23 determines whether the ODD is satisfied. When the ODD is satisfied, the operation proceeds to S103. When the ODD is unsatisfied, the operation proceeds to S104.

The controller 23 determines, based on the data measured by the sensor 12A, whether the vehicle 10 satisfies the ODD.

S103: The controller 23 continues the travel of the vehicle 10 in the automated driving mode AD.

S104: The controller 23 determines, based on the data measured by the sensor 12A, a factor for which the ODD has become unsatisfied.

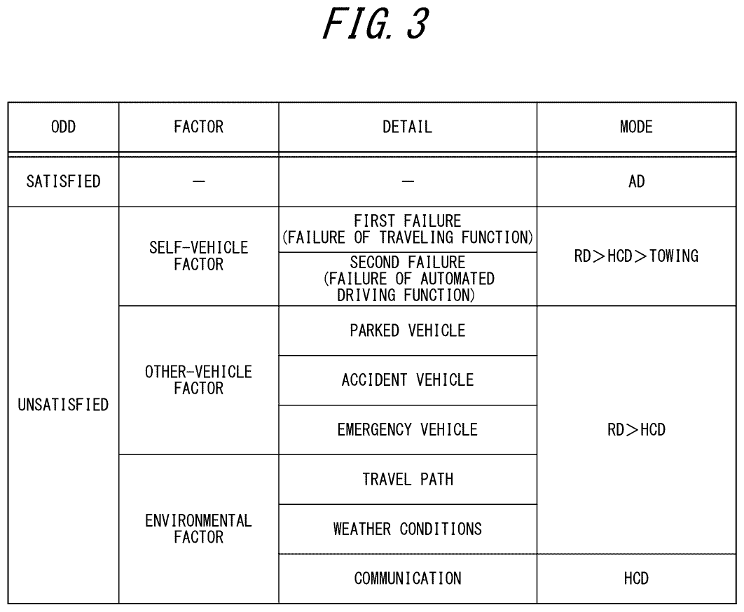

FIG. 3 is a table illustrating an example of transitions of driving modes depending on factors for which the ODD is unsatisfied. As illustrated in FIG. 3, the factors for which the ODD is unsatisfied include a self-vehicle factor, an other-vehicle factor, and an environmental factor. The self-vehicle factor includes a first failure by which the vehicle 10 cannot travel by itself, i.e., in which the driving function of the vehicle 10 fails, and a second failure by which the vehicle 10 cannot travel by automated driving, i.e., in which the driving function of the vehicle 10 is normal but the automated driving function of the vehicle 10 fails. The other-vehicle factor is that passage of the vehicle 10 is restricted by a stopped or parked vehicle, an accident vehicle, or an emergency vehicle obstructing a travel path of the vehicle 10. The environmental factor includes that passage of the vehicle 10 is restricted due to road conditions of the travel path of the vehicle 10 or weather conditions, and that communication connection between the vehicle 10 and the remote driving apparatus 40 cannot be established. In FIG. 3, for example, the notation “RD>HCD>towing” means that, from the perspective of operational costs, handling manhours, and the like, a transition from the automated driving mode AD to the remote driving mode RD is a first priority, a transition to the temporary manual driving mode HCD is a second priority, and a transition to towing is a third priority.

Data for determining that the ODD is unsatisfied due to a self-vehicle factor (first or second failure) can be obtained, for example, from the sensors that are mounted on the self-diagnostic apparatus or the like of the vehicle 10 to diagnose a failure mode. Data for determining an other-vehicle factor or an environmental factor (excluding communication connection) can be obtained from outside the vehicle 10 using the cameras, the 3D-LiDAR, the millimeter wave sensors, and the like. Data for determining an environmental factor (communication connection) can be obtained from the communication interface 21.

The temporary manual driving mode HCD is a control mode for manually driving the vehicle 10 according to a request from the server 30, by an operator accompanying the rescue team 4, which has rushed to a location at which the vehicle 10 has stopped, installing the temporary manual driving apparatus 50 on the vehicle 10 and manually operating the installed temporary manual driving device 50. On the other hand, the remote driving mode RD is a control mode for manually driving the vehicle 10 by remote operations from the remote driving apparatus 40 provided in the operation management center 3, which can communicate with the vehicle 10.

S105-S110: While the vehicle 10 is traveling in the automated driving mode AD, the controller 23 requests a transition of the driving modes to the server 30, based on the data measured by the sensor 12A, when the operational design domain (ODD) has become unsatisfied. The transition of the driving modes includes (i) a transition from the automated driving mode AD to the temporary manual driving mode HCD (hereinafter referred to as a first transition), (ii) a transition from the automated driving mode AD to the remote driving mode RD (hereinafter referred to as a second transition), and (iii) towing of the vehicle 10. The controller 23 requests, to the server 30, one of (i) the first transition, (ii) the second transition, or (iii) towing, based on the factor for which the operational design domain (ODD) has become unsatisfied, which is determined in S104. The request for the transition of the driving modes will be described below in detail.

S105: The controller 23 determines whether the factor for which the ODD has become unsatisfied is a first failure, by which the vehicle 10 cannot travel by itself, among a self-vehicle factor. When the factor is a first failure, the operation proceeds to S106. When the factor is not a first failure, the operation proceeds to S107.

In the first failure, the vehicle 10 loses the driving functions (running, turning, and stopping functions) and becomes unable to travel by itself.

S106: The controller 23 requests, to the server 30, the towing of the vehicle 10.

In such a case, the controller 23 requests, to the server 30, the towing of the vehicle 10 by an operator accompanying the rescue team 4, including the dispatch of the rescue team 4 to a location at which the vehicle 10 stops. The controller 23 may request the provision of an alternative vehicle, along with the towing of the vehicle 10.

S107: The controller 23 determines whether establishment of the communication connection between the vehicle 10 and the remote driving apparatus 40 is possible. When the establishment of the communication connection is possible, the operation proceeds to S109. When the establishment of the communication connection is impossible, the operation proceeds to S108.

The reason why the establishment of the communication connection is impossible may be, as an environmental factor, the vehicle 10 traveling in an area with an issue in internet connection environment or in an area in which internet connection environment is not built, but is not limited to these.

S108: The controller 23 requests, to the server 30, the first transition that is a transition from the automated driving mode AD to the temporary manual driving mode HCD.

In a case in which it has been determined that the factor for which the ODD has become unsatisfied is a second failure, by which the vehicle 10 cannot travel by automated driving, among a self-vehicle factor, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4, when the communication connection between the vehicle 10 and the remote driving apparatus 40 cannot be established.

In a case in which it has been determined that the factor for which the ODD has become unsatisfied is an other-vehicle factor, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4, when the communication connection between the vehicle 10 and the remote driving apparatus 40 cannot be established.

In a case in which it has been determined that the factor for which the ODD has become unsatisfied is an environmental factor, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4, when the communication connection between the vehicle 10 and the remote driving apparatus 40 cannot be established.

Note that, when communication connection with the vehicle 10 is not established for a predetermined time or more, the server 30 may request, to the rescue team 4, the first transition including the dispatch of the rescue team 4 to an area at which the vehicle 10 is expected to be located and the temporary installation of the temporary manual driving apparatus 50 on the vehicle 10 by the operator accompanying the rescue team 4.

S109: The controller 23 determines whether a predetermined condition α is satisfied. When the predetermined condition α is satisfied, the operation proceeds to S110. When the predetermined condition α is unsatisfied, the operation returns to S108.

The predetermined condition α is that an operator with knowledge or skill to manually operate the remote driving apparatus 40 is in a state capable of responding to a request for the second transition. Whether the predetermined condition α is satisfied can be determined by inquiring the server 30 via the network 2.

Furthermore, (i) in a case in which it has been determined that the factor for which the ODD has become unsatisfied is a second failure, among a self-vehicle factor, and (ii) when the predetermined condition α is unsatisfied, even when the vehicle 10 can travel by itself and the communication connection between the vehicle 10 and the remote driving apparatus 40 can be established, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4.

Furthermore, (i) in a case in which it has been determined that the factor for which the ODD has become unsatisfied is an other-vehicle factor, and (ii) when the predetermined condition α is unsatisfied, even when the vehicle 10 can travel by itself and the communication connection between the vehicle 10 and the remote driving apparatus 40 can be established, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4.

Furthermore, (i) in a case in which it has been determined that the factor for which the ODD has become unsatisfied is an environmental factor, and (ii) when the predetermined condition α is unsatisfied, even when the vehicle 10 can travel by itself and the communication connection between the vehicle 10 and the remote driving apparatus 40 can be established, the controller 23 requests, to the server 30, the first transition including the dispatch of the rescue team 4 to the location at which the vehicle 10 stops and the temporary installation of the temporary manual driving apparatus 50 on the vehicle 10 by the operator accompanying the rescue team 4.

S110: When it has been determined that the transition from the automated driving mode AD to the remote driving mode RD is possible, the controller 23 requests, to the server 30, the second transition that is a transition from the automated driving mode AD to the remote driving mode RD.

In a case in which it has been determined that the factor for which the ODD has become unsatisfied is a second failure, by which the vehicle 10 cannot travel by automated driving, among a self-vehicle factor, the controller 23 requests, to the server 30, the second transition including the establishment of the communication connection between the vehicle 10 and the remote driving apparatus 40, when the vehicle 10 can travel by itself, when the communication connection can be established, and when the predetermined condition α is satisfied.

In a case in which it has been determined that the factor for which the ODD has become unsatisfied is an other-vehicle factor, the controller 23 requests, to the server 30, the second transition including the establishment of the communication connection between the vehicle 10 and the remote driving apparatus 40, when the vehicle 10 can travel by itself, when the communication connection can be established, and when the predetermined condition α is satisfied.

In a case in which it has been determined that the factor for which the ODD has become unsatisfied is an environmental factor, the controller 23 requests, to the server 30, the second transition including the establishment of the communication connection between the vehicle 10 and the remote driving apparatus 40, when the vehicle 10 can travel by itself, when the communication connection can be established, and when the predetermined condition α is satisfied.

The controller 23 may stop the vehicle 10 at a location at which stopping is permitted, until the communication connection with the remote driving apparatus 40 is established, or until the rescue team 4 arrives. The location at which stopping is permitted is a place at which the vehicle 10 can be quickly stopped and can safely wait for the arrival of the rescue team 4, such as a shoulder of a roadway or a parking lot facing a roadway.

Step S111: The controller 23 determines whether the vehicle 10 that can travel by itself has arrived at a destination, or whether the towing of the vehicle 10 that cannot travel by itself has been completed. When the vehicle 10 that can travel by itself has arrived at the destination, or when the towing of the vehicle 10 that cannot travel by itself has been completed, the determination apparatus 20 ends the information processing. When the vehicle 10 that can travel by itself has not arrived at the destination, or when the towing of the vehicle 10 that cannot travel by itself has not been completed, the operation returns to S101 and continues the information processing.

As described above, while the vehicle 10 that has the automated driving mode AD and the temporary manual driving mode HCD, which becomes selectable by connecting the temporary manual driving apparatus 50, is traveling in the automated driving mode AD, the determination apparatus 20 according to the present embodiment requests the first transition that is a transition from the automated driving mode AD to the temporary manual driving mode HCD, when the operational design domain enabling automated driving has become unsatisfied.

According to such a configuration, while the vehicle 10 is traveling by automated driving, the determination apparatus 20 autonomously requests a transition from the automated driving mode to the temporary manual driving mode when the operational design domain has become unsatisfied. As a result, time for the transition from the automated driving mode to the temporary manual driving mode is further reduced. It also becomes possible to smoothly take fail-safe measures even in situations in which automated driving is impossible, thereby improving technology for automatically controlling travel of vehicles.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

In the above-described embodiment, it is also possible to implement an embodiment in which the configuration and operations of the determination apparatus 20 are distributed to multiple computers capable of communicating with each other. For example, some or all of the components of the determination apparatus 20 may be provided in the server 30, instead of the vehicle 10. Additionally, an embodiment in which some or all of the components of the determination apparatus 20 are provided in the vehicle 10 is also possible.

In the above-described embodiment, it has been explained that the operation management center 3 is provided with one remote driving apparatus 40, but when an operation area is extensive, the operation management center 3 may have multiple remote driving apparatuses 40 for each area. Furthermore, the rescue center at which the rescue team 4 is on standby may be provided in the operation management center 3, or the remote driving apparatus 40 may be installed in the rescue center.

In the above-described embodiment, it has been explained that the vehicle 10 on which the determination apparatus 20 is mounted is an automobile, but the determination apparatus 20 may also be mounted on other mobility apparatuses, such as motorboats or drones that navigate automatedly.

An embodiment in which a general purpose computer functions as the determination apparatus 20 according to the above embodiment is also possible. Specifically, a program in which processes for realizing the functions of the determination apparatus 20 according to the above embodiment are written may be stored in a memory of a general purpose computer, and the program may be read and executed by a processor. Accordingly, the present disclosure can also be implemented as a program executable by a processor, or a non-transitory computer readable medium storing the program.

Examples of some embodiments of the present disclosure are described below. However, it should be noted that the embodiments of the present disclosure are not limited to these examples.

[Appendix 1] A determination apparatus comprising a controller configured to:
acquire data measured by a sensor provided in a vehicle that has an automated driving mode and a temporary manual driving mode, the temporary manual driving mode becoming selectable by connecting a temporary manual driving apparatus; and
while the vehicle is traveling based on the data in the automated driving mode, request a first transition that is a transition from the automated driving mode to the temporary manual driving mode, when an operational design domain enabling automated driving has become unsatisfied.

[Appendix 2] The determination apparatus according to appendix 1, wherein the sensor including a camera, 3D-LiDAR, a millimeter wave sensor, an acceleration sensor, or a GPS sensor includes a sensor configured to monitor environment around the vehicle that travels by automated driving, and a sensor configured to diagnose a failure mode of the vehicle.

[Appendix 3] A determination apparatus comprising a controller configured to, while a vehicle that has an automated driving mode and a temporary manual driving mode becoming selectable by connecting a temporary manual driving apparatus is traveling in the automated driving mode, request a first transition that is a transition from the automated driving mode to the temporary manual driving mode when an operational design domain enabling automated driving has become unsatisfied.

[Appendix 4] The determination apparatus according to appendix 3, wherein the temporary manual driving mode is a control mode for manually driving the vehicle according to a request, by manually operating the temporary manual driving apparatus temporarily provided in the vehicle.

[Appendix 5] The determination apparatus according to appendix 3, wherein the controller is configured to request a second transition that is a transition from the automated driving mode to a remote driving mode, upon determining that the transition from the automated driving mode to the remote driving mode is possible.

[Appendix 6] The determination apparatus according to appendix 5, wherein the remote driving mode is a control mode for manually driving the vehicle by a remote operation from a remote driving apparatus communicable to the vehicle.

[Appendix 7] The determination apparatus according to appendix 3, wherein the controller is configured to determine a factor for which the operational design domain has become unsatisfied,
the factor is one of a self-vehicle factor, an other-vehicle factor, or an environmental factor,
the self-vehicle factor includes a first failure by which the vehicle cannot travel by itself, and a second failure by which the vehicle cannot travel by automated driving,
the other-vehicle factor is that passage of the vehicle is restricted by a stopped or parked vehicle, an accident vehicle, or an emergency vehicle obstructing a travel path of the vehicle, and
the environmental factor includes that passage of the vehicle is restricted due to a road condition of the travel path or a weather condition, and that communication connection between the vehicle and a remote driving apparatus cannot be established.

[Appendix 8] The determination apparatus according to appendix 7, wherein in a case in which it has been determined that the factor is the first failure among the self-vehicle factor, the controller is configured to request towing of the vehicle.

[Appendix 9] The determination apparatus according to appendix 7, wherein in a case in which it has been determined that the factor is the second failure among the self-vehicle factor, the controller is configured to request a second transition that is a transition from the automated driving mode to a remote driving mode, when the vehicle can travel by itself, when the communication connection between the vehicle and the remote driving apparatus can be established, and when a predetermined condition is satisfied.

[Appendix 10] The determination apparatus according to appendix 9, wherein the controller is configured to request the first transition when the predetermined condition is unsatisfied.

[Appendix 11] The determination apparatus according to appendix 7, wherein in a case in which it has been determined that the factor is the second failure among the self-vehicle factor, the controller is configured to request the first transition when the communication connection between the vehicle and the remote driving apparatus cannot be established.

[Appendix 12] The determination apparatus according to appendix 7, wherein in a case in which it has been determined that the factor is the other-vehicle factor, the controller is configured to request a second transition that is a transition from the automated driving mode to a remote driving mode, when the vehicle can travel by itself, when the communication connection between the vehicle and the remote driving apparatus can be established, and a predetermined condition is satisfied.

[Appendix 13] The determination apparatus according to appendix 12, wherein the controller is configured to request the first transition when the predetermined condition is unsatisfied.

[Appendix 14] The determination apparatus according to appendix 7, wherein in a case in which it has been determined that the factor is the other-vehicle factor, the controller is configured to request the first transition when the communication connection between the vehicle and the remote driving apparatus cannot be established.

[Appendix 15] The determination apparatus according to appendix 7, wherein in a case in which it has been determined that the factor is the environmental factor, the controller is configured to request a second transition that is a transition from the automated driving mode to a remote driving mode, when the vehicle can travel by itself, when the communication connection between the vehicle and the remote driving apparatus can be established, and when a predetermined condition is satisfied.

[Appendix 16] The determination apparatus according to appendix 15, wherein the controller is configured to request the first transition when the predetermined condition is unsatisfied.

[Appendix 17] The determination apparatus according to appendix 7, wherein in a case in which it has been determined that the factor is the environmental factor, the controller is configured to request the first transition when the communication connection between the vehicle and the remote driving apparatus cannot be established.

[Appendix 18] A determination method comprising, while a vehicle that has an automated driving mode and a temporary manual driving mode becoming selectable by connecting a temporary manual driving apparatus is traveling in the automated driving mode, requesting, by a determination apparatus, a first transition that is a transition from the automated driving mode to the temporary manual driving mode, when an operational design domain enabling automated driving has become unsatisfied.

[Appendix 19] The determination method according to appendix 18, wherein the temporary manual driving mode is a control mode for manually driving the vehicle according to a request, by manually operating the temporary manual driving apparatus temporarily provided in the vehicle.

[Appendix 20] The determination method according to appendix 18, comprising requesting, by the determination apparatus, a second transition that is a transition from the automated driving mode to a remote driving mode, when it has been determined that the transition from the automated driving mode to the remote driving mode is possible.

1. A determination apparatus comprising a controller configured to:
acquire data measured by a sensor provided in a vehicle that has an automated driving mode and a temporary manual driving mode, the temporary manual driving mode becoming selectable by connecting a temporary manual driving apparatus; and
while the vehicle is traveling based on the data in the automated driving mode, request a first transition that is a transition from the automated driving mode to the temporary manual driving mode, when an operational design domain enabling automated driving has become unsatisfied.

2. The determination apparatus according to claim 1, wherein the sensor including a camera, 3D-LiDAR, a millimeter wave sensor, an acceleration sensor, or a GPS sensor includes a sensor configured to monitor environment around the vehicle that travels by automated driving, and a sensor configured to diagnose a failure mode of the vehicle.

3. A determination apparatus comprising a controller configured to, while a vehicle that has an automated driving mode and a temporary manual driving mode becoming selectable by connecting a temporary manual driving apparatus is traveling in the automated driving mode, request a first transition that is a transition from the automated driving mode to the temporary manual driving mode when an operational design domain enabling automated driving has become unsatisfied.

4. The determination apparatus according to claim 3, wherein the temporary manual driving mode is a control mode for manually driving the vehicle according to a request, by manually operating the temporary manual driving apparatus temporarily provided in the vehicle.

5. The determination apparatus according to claim 3, wherein the controller is configured to request a second transition that is a transition from the automated driving mode to a remote driving mode, upon determining that the transition from the automated driving mode to the remote driving mode is possible.

6. The determination apparatus according to claim 5, wherein the remote driving mode is a control mode for manually driving the vehicle by a remote operation from a remote driving apparatus communicable to the vehicle.

7. The determination apparatus according to claim 3, wherein
the controller is configured to determine a factor for which the operational design domain has become unsatisfied,
the factor is one of a self-vehicle factor, an other-vehicle factor, or an environmental factor,
the self-vehicle factor includes a first failure by which the vehicle cannot travel by itself, and a second failure by which the vehicle cannot travel by automated driving,
the other-vehicle factor is that passage of the vehicle is restricted by a stopped or parked vehicle, an accident vehicle, or an emergency vehicle obstructing a travel path of the vehicle, and
the environmental factor includes that passage of the vehicle is restricted due to a road condition of the travel path or a weather condition, and that communication connection between the vehicle and a remote driving apparatus cannot be established.

8. The determination apparatus according to claim 7, wherein in a case in which it has been determined that the factor is the first failure among the self-vehicle factor, the controller is configured to request towing of the vehicle.

9. The determination apparatus according to claim 7, wherein in a case in which it has been determined that the factor is the second failure among the self-vehicle factor, the controller is configured to request a second transition that is a transition from the automated driving mode to a remote driving mode, when the vehicle can travel by itself, when the communication connection between the vehicle and the remote driving apparatus can be established, and when a predetermined condition is satisfied.

10. The determination apparatus according to claim 9, wherein the controller is configured to request the first transition when the predetermined condition is unsatisfied.

11. The determination apparatus according to claim 7, wherein in a case in which it has been determined that the factor is the second failure among the self-vehicle factor, the controller is configured to request the first transition when the communication connection between the vehicle and the remote driving apparatus cannot be established.

12. The determination apparatus according to claim 7, wherein in a case in which it has been determined that the factor is the other-vehicle factor, the controller is configured to request a second transition that is a transition from the automated driving mode to a remote driving mode, when the vehicle can travel by itself, when the communication connection between the vehicle and the remote driving apparatus can be established, and a predetermined condition is satisfied.

13. The determination apparatus according to claim 12, wherein the controller is configured to request the first transition when the predetermined condition is unsatisfied.

14. The determination apparatus according to claim 7, wherein in a case in which it has been determined that the factor is the other-vehicle factor, the controller is configured to request the first transition when the communication connection between the vehicle and the remote driving apparatus cannot be established.

15. The determination apparatus according to claim 7, wherein in a case in which it has been determined that the factor is the environmental factor, the controller is configured to request a second transition that is a transition from the automated driving mode to a remote driving mode, when the vehicle can travel by itself, when the communication connection between the vehicle and the remote driving apparatus can be established, and when a predetermined condition is satisfied.

16. The determination apparatus according to claim 15, wherein the controller is configured to request the first transition when the predetermined condition is unsatisfied.

17. The determination apparatus according to claim 7, wherein in a case in which it has been determined that the factor is the environmental factor, the controller is configured to request the first transition when the communication connection between the vehicle and the remote driving apparatus cannot be established.

18. A determination method comprising, while a vehicle that has an automated driving mode and a temporary manual driving mode becoming selectable by connecting a temporary manual driving apparatus is traveling in the automated driving mode, requesting, by a determination apparatus, a first transition that is a transition from the automated driving mode to the temporary manual driving mode, when an operational design domain enabling automated driving has become unsatisfied.

19. The determination method according to claim 18, wherein the temporary manual driving mode is a control mode for manually driving the vehicle according to a request, by manually operating the temporary manual driving apparatus temporarily provided in the vehicle.

20. The determination method according to claim 18, comprising requesting, by the determination apparatus, a second transition that is a transition from the automated driving mode to a remote driving mode, when it has been determined that the transition from the automated driving mode to the remote driving mode is possible.
